(19) United States
(12) Patent Application Publication
(10) Pub. No.: US 2006/0254707 A1
(43) Pub. Date: Nov. 16, 2006

(54) Glass lens with decorated anti-splinter film

(76) Inventor: Raymond Charles Iandoli, Longwood, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/412,072

(22) Filed: Apr. 26, 2006

Related U.S. Application Data
(63) Continuation-in-part of application No. 11/175,945, filed on Jul. 6, 2005.
(60) Provisional application No. 60/678,135, filed on May 5, 2005.

(51) Int. Cl. B32B 37/00

(52) U.S. Cl. 156/256; 156/289

(57) ABSTRACT

A method of manufacturing a decorated, splinter resistant glass lens for a personal electronic device includes applying a decoration to an anti-splinter film and then applying a release film backed adhesive to the anti-splinter film. The method also includes die-cutting the anti-splinter film and the adhesive into a die cut film portion corresponding to a glass lens blank and removing the die cut film portion from the release film. The method further includes aligning the die cut film portion with respect to the glass lens blank and bonding the die cut film portion to the glass lens blank.

### SPECIFIC DATA RELATED TO THE INVENTION

This application is a continuation in part (CIP) of and claims the benefit of the Jul. 6, 2005 filing date of U.S. patent application Ser. No. 11/175,945, which in turn claims the benefit of the May 5, 2005 filing date of U.S. Provisional Application No. 60/678,135.

### FIELD OF THE INVENTION

The present invention relates to safety glass and, in particular, to a glass lens for a cell phone having a decorated anti-splinter film.

### BACKGROUND OF THE INVENTION

Electronic devices such as computer monitors, cellular and PCS telephones, Internet appliances, personal digital assistants (PDAs), home audio equipment, and kitchen appliances may include decorated glass lenses. Typically, a multi-step process performed by different machines may need to be used to produce such decorated glass lenses. For example, each glass lens may need to be individually printed in separate printing steps according to different colors desired to be printed. Some decorating processes may include a vacuum metallization step that is known to weaken the glass. In addition to decorations, glass lenses used in such applications may need to be rendered shatter or splinter resistant for safety reasons.

### BRIEF DESCRIPTION OF THE DRAWINGS

FIG. 1 shows an exploded view of an exemplary embodiment of a glass lens with decorated anti-splinter film.

FIG. 2 shows a perspective view of an exemplary embodiment of a rolled anti-splinter film sheet.

FIG. 3 depicts an exemplary embodiment of a lamination process for laminating an adhesive film to an anti-splinter film.

FIG. 4 shows an exemplary alignment border applied to a glass lens blank.

### DETAILED DESCRIPTION OF THE INVENTION

The present invention is directed to a decorated film used as an anti-splinter feature when bonded to a glass lens. As used herein, decorated film includes any type of coating applied to a film, such as an ink coating, a conductive ink coating, a metallic sputtered coating, an antireflective coating, an easy clean coating, an antimicrobial coating, etc. The decorated anti-splinter film serves as both a decorative element and a safety element to prevent glass splinters and/or particles from dispersing if the glass lens is broken. Advantageously, the innovative method of manufacturing the glass lens allows the glass lens to be produced with fewer steps than would typically be required.

FIG. 1 shows an exploded view of an exemplary embodiment of a glass lens 10 having a decorated anti-splinter film 16. The glass lens 10 may include a glass blank 12 sized to fit a desired appliance, such as a cell phone face plate. The glass blank 12 may be formed from a silica based glass, such as float glass available from glass manufacturers such as Corning, Incorporated or Shott, Incorporated. In an aspect of the invention, the glass has a thickness t_{g} less than about 2.54 millimeters (mm), and preferably has a thickness t_{g} of between about 0.2 mm to 1.5 mm, and more preferably has a thickness t_{g} of between about 0.2 mm to 1.0 mm. An adhesive layer 14 bonds the decorated anti-splinter film 16 to the surface 18 of the glass blank 12. The adhesive layer 14 includes an optically clear adhesive having a thickness tₐ of between about 0.0051 mm and 0.254 mm and preferably having a thickness tₐ of between about 0.0127 mm and 0.127 mm. An adhesive used in the adhesive layer 14 may include an acrylic based, polymer based, and/or an ultraviolet (UV) bondable material. Suitable adhesives may include optically clear adhesives, acrylic based, or polymer based and are available from companies such as 3M, Nitto Denko, Mactac, or Adhesive Research.

The anti-splinter film 16 bonded to the surface 18 of the glass blank 12 by the adhesive layer 14 may include an optically clear plastic having a thickness t_{f} of between about 0.0051 mm and 0.508 mm, and preferably between about 0.0508 mm and 0.127 mm. The anti-splinter film 16 may include a polycarbonate, a polyethylene terephthalate (PET), polyester, transflective, and/or an acrylic material, and may include multiple layers of film. Suitable films may include OQ1030 Lexan®, available from General Electric Corporation, Mylar® or Melinex®, available from DuPont Corporation, or similar products such as polyester films available from Mitsubishi, SKC, or transflective films available from 3M.

In an aspect of the invention, the anti-splinter film 16 may be decorated before being adhered to the glass blank 12. The film 16 may be decorated on an upper surface 22 or a lower surface 24. A decoration 26 may be applied using vacuum metallization techniques such as sputtering, electron beam or evaporation. In another embodiment, the decoration 26 may be applied using a printing technique such as a gravure process, offset lithography, tampo printing, and/or digital printing. In a cell phone lens application, the decoration 26 may include desired indicia applied around a perimeter 20 of the film 16 leaving sufficient room in a central portion 28 of the film 16 to allow a cell phone display to be viewed through the central portion 28 of the film 16.

A manufacturing process for producing the glass lens 10 with the decorated anti-splinter film 16 may include applying a decoration 26 to at least one surface of the anti-splinter film 16 using, for example, a vacuum metallization or printing technique. The decorated anti-splinter film 16 is than bonded to the glass blank 12 with an adhesive to form the glass lens 10. The adhesive may be applied to the lower surface 24 of the anti-splinter film 16, the surface 18 of the glass blank 12, or both surfaces 18, 24.

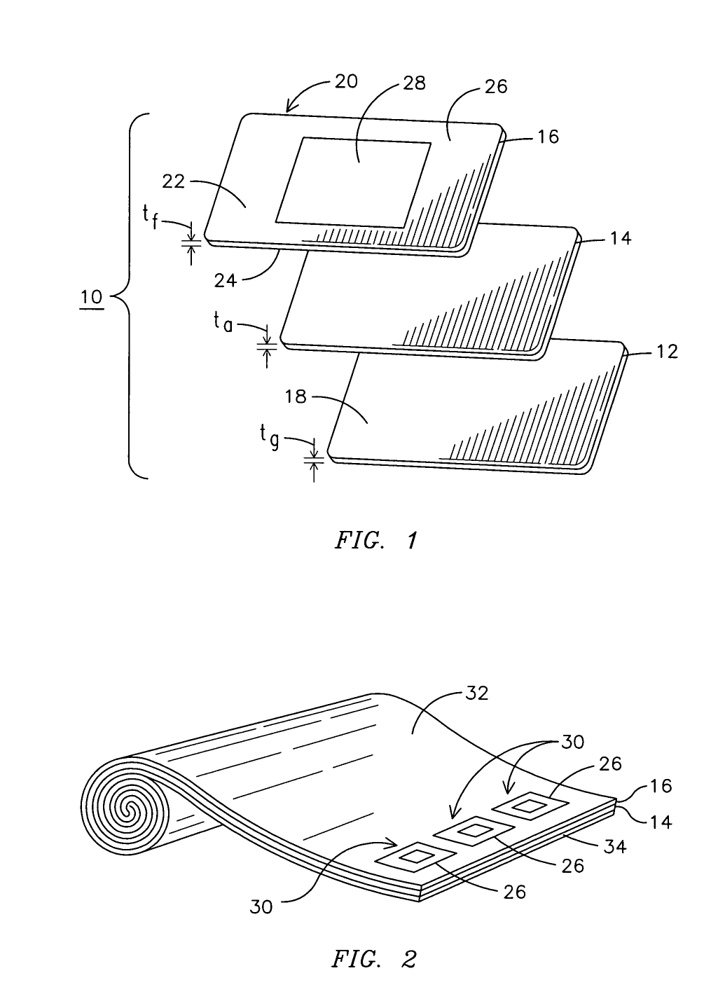

In an embodiment of the invention depicted in FIG. 2, the anti-splinter film 16 may be provided in a rolled sheet 32 and the decoration 26 applied to respective portions 30 of the sheet 32 corresponding, for example, to a desired glass blank size. Each of the decorated portions 30 of the sheet 32 may then be die cut and adhered to a respective glass blank 12 using an adhesive. In an aspect of the invention, the rolled sheet 32 may be provided with an adhesive layer 14 pre-applied to one of the surfaces of the sheet 32, and may include a release film 34 applied over the adhesive layer 14. Respective decorations 26 may be applied to a surface of the sheet opposite to the adhesive layer 14. The respective decorated portions 30 may then be die cut, so that the cut extends through the decorated anti-splinter film 16 and adhesive layer 14, but not the release film 34. Each of the die cut portions 30 may then be removed from the release film 34 and applied, adhesive side down, to a correspondingly sized glass blank.

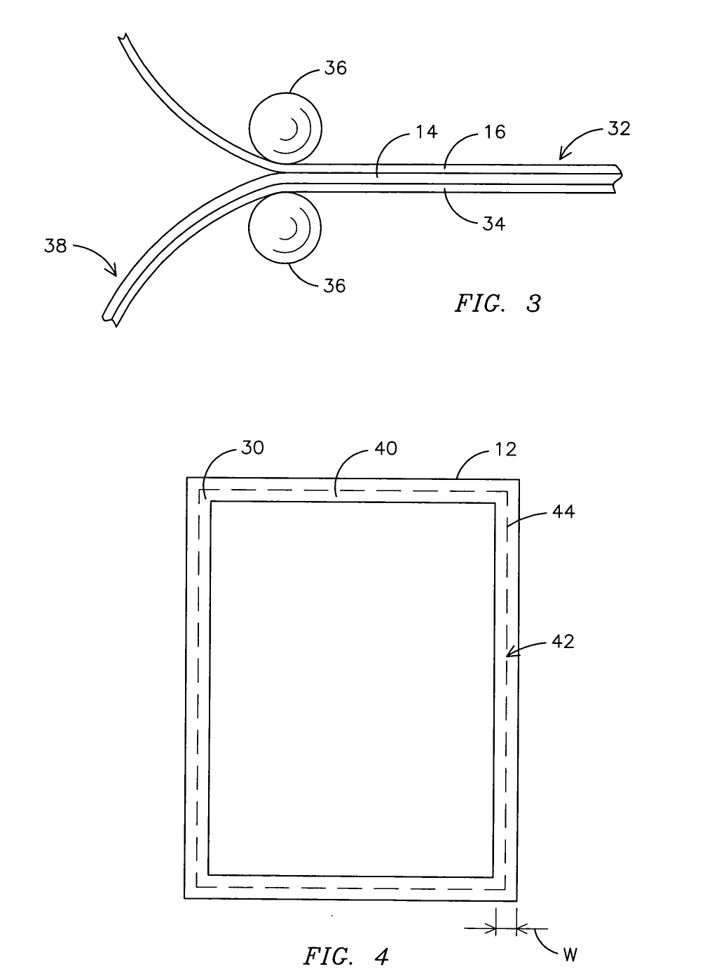

An exemplary method of manufacturing a decorated, splinter resistant glass lens may include the steps of applying a decoration, such as printed indicia or a coating, to an anti-splinter film 16 and then applying a release film backed adhesive 38 to the anti-splinter film 16, such as by using a lamination process depicted in FIG. 3. The lamination process may include compressing an adhesive layer 14 of a release film backed adhesive film 38 and the anti-splinter film 16 together, such as by compressing the films together between rollers 36. The method may further include die-cutting the anti-splinter film 16 and the adhesive layer 14 into a die cut film portion 30 as shown in FIG. 2 corresponding to a glass lens blank 12 so that the release film remains intact. The method may further include removing the die cut film portion from the release film, such as by using a movable vacuum chuck to grip and remove the portion 30. The method then includes aligning the die cut film portion 30 with respect to the glass lens blank 12 as shown in FIG. 1 and bonding the die cut film portion 30 to the glass lens blank 12 via the adhesive layer 14. In an embodiment, alignment of the portion 30 with the glass lens blank 12 may be accomplished using a conventional visual alignment system to align a center of the portion 30 with a center of the glass lens blank 12 and/or to align one or more edges of the portion 30 with one or more edges of the glass lens blank 12.

In another embodiment depicted in FIG. 4, the manufacturing method may include applying a border coating 40 to at least one edge portion 42 of the glass lens blank 12 before bonding the die cut film portion 30 to the glass lens blank 12. The border coating 40 serves to compensate for misalignment and/or mis-sizing of the die cut film portion 30 with respect to the edge portion 42 of the glass lens blank 12. For example, it may be difficult to align a central portion 28 of the film 16 as seen in FIG. 1 with a corresponding central portion of the glass lens blank 12 while also assuring that the edges of the film 16 are aligned with the edges of the glass lens blank 12 within a predetermined alignment tolerance. Consequently, the die cut film portion 30 may be deliberately misaligned with the edge portion 42 to ensure a central portion 28 is aligned. In addition, the die cut film portion 30 may be deliberately undersized so that the portion 30 doesn't extend over one or more edges of the glass lens blank 12 when applied. Accordingly, the border coating 42 allows increased alignment tolerance around the edges of the glass lens blank 12 so that a central alignment of the film 16 may be optimized. As indicated in FIG. 4 by the phantom lines 44, the edges of the portion 30 may overlap the border 40 to compensate for misalignment and/or mis-sizing of the die cut film portion 30. In an exemplary embodiment, the border coating 42 may be printed on the glass lens blank 12 using a pad printing or screen printing technique. In an exemplary embodiment, a width, w, of the border coating 42 may range from about 0.5 mm to about 2.0 mm.

In another aspect of the invention, the decoration may include a coating applied to one or more sides of the anti-splinter film, for example in a continuous roll to roll coating process. The coating may be applied before applying the adhesive to the film. The coating may include one or more of an antireflective coating, a conductive ink coating, an easy clean coating and an anti-microbial coating.

Although several embodiments of the present invention and its advantages have been described in detail, it should be understood that mutations, changes, substitutions, transformations, modifications, variations, and alterations can be made therein without departing from the teachings of the present invention, the spirit and scope of the invention being set forth by the appended claims.

What is claimed is:

1. A method of manufacturing a decorated, splinter resistant glass lens for a personal electronic device comprising:
applying a decoration to an anti-splinter film;
applying a release film backed adhesive to the anti-splinter film,
die-cutting the anti-splinter film and the adhesive into a die cut film portion corresponding to a glass lens blank;
removing the die cut film portion from the release film;
aligning the die cut film portion with respect to the glass lens blank; and
bonding the die cut film portion to the glass lens blank.

2. The method of claim 1, further comprising applying a border coating to at least one edge portion of a surface of the glass lens blank before bonding the die cut film portion to the glass lens blank, the border coating being effective to compensate for misalignment of the die cut film portion with respect to the edge portion of the glass lens blank.

3. The method of claim 2, wherein the border coating has a width ranging from about 0.5 mm to about 2.0 mm.

4. The method of claim 1, wherein applying a release film backed adhesive to the anti-splinter film comprises a lamination process.

5. The method of claim 1, wherein laminating comprises compressing the adhesive side of the release-backed adhesive film and the anti-splinter film together.

6. The method of claim 1, wherein aligning the die cut film portion with respect to the glass blank comprises aligning a center of the die cut film portion with a corresponding center of the glass blank.

7. The method of claim 1, wherein applying a decoration comprises a printing step.

8. The method of claim 1, wherein applying a decoration comprises a vacuum metallization step.

9. The method of claim 1, wherein the decoration comprises an antireflective coating.

10. The method of claim 1, wherein the decoration comprises an easy clean coating.

11. The method of claim 1, wherein the decoration comprises a conductive ink coating.

12. A decorated, splinter resistant glass lens produced using the method of claim 1.
